(19) United States
(12) Patent Application Publication
(10) Pub. No.: US 2026/0331820 A1
(43) Pub. Date: Oct. 22, 2026

(54) Waterproof Electrical Connector

(71) Applicants: TE Connecitivity Japan G. K., Kawasaki-shi (JP); Tyco Electronics Technology (SIP) Co., Ltd., Suzhou (CN)

(72) Inventors: Yuejie Wang, Suzhou (CN); Shunsuke Nakamura, Kawasaki-shi (JP); Hidehisa Yamagami, Kawasaki-shi (JP)

(73) Assignees: TE Connecitivity Japan G. K., Kawasaki-shi (JP); Tyco Electronics Technology (SIP) Co., Ltd., Suzhou (CN)

(21) Appl. No.: 19/712,338

(22) Filed: Jun. 18, 2026

Related U.S. Application Data
(63) Continuation of application No. PCT/CN2023/139450, filed on Dec. 18, 2023.

(51) Int. Cl. H01R 13/52; H01R 13/621; H01R 24/28

(52) U.S. Cl. CPC H01R 13/5202; H01R 13/5219; H01R 13/6215; H01R 24/28

(57) ABSTRACT

A waterproof electrical connector includes an annular seal member and a seal receiving housing. The seal receiving housing has a seal groove. The seal member is provided in the seal groove between an inner wall arranged inwardly in a radial direction and an outer wall arranged outwardly in the radial direction relative to the inner wall. The outer wall has first regions and second regions. The first regions have a dimension in the radial direction. The second regions have a dimension in the radial direction greater than the dimension of the first region. A curvature of the first regions are smaller than a curvature of the second regions.

### CROSS-REFERENCE TO RELATED APPLICATIONS

This application claims the benefit of the filing date under 35 U.S.C. § 119(a)-(d) of PCT Application No. PCT/CN2023/139450, filed on Dec. 18, 2023.

### FIELD OF THE INVENTION

The present invention relates to a connector and, more particularly, to a waterproof electrical connector.

### BACKGROUND OF THE INVENTION

Conventionally, among electrical connectors, waterproof electrical connectors that prevent water from entering the connecting portion with a mating side connector have been known. An electrical connector, which is fastened to a mating side connector with bolts and sealed by making an elastic sealing component that is mounted in a groove of a housing against an annular protrusion, is disclosed in Japanese Patent Application Publication No. 2010-140873. In the electrical connector of Japanese Patent Application Publication No. 2010-140873, both the elastic sealing component and the groove are circular in shape, but since the elastic sealing component is compressed in its axial direction and expands in a radial direction, a margin that anticipates the expansion, i.e., an expansion allowance is arranged in the groove.

### SUMMARY OF THE INVENTION

A waterproof electrical connector includes an annular seal member and a seal receiving housing. The seal receiving housing has a seal groove. The seal member is provided in the seal groove between an inner wall arranged inwardly in a radial direction and an outer wall arranged outwardly in the radial direction relative to the inner wall. The outer wall has first regions and second regions. The first regions have a dimension in the radial direction. The second regions have a dimension in the radial direction greater than the dimension of the first region. A curvature of the first regions are smaller than a curvature of the second regions.

### BRIEF DESCRIPTION OF DRAWINGS

The invention will now be described by way of example with reference to the accompanying figures, of which:

FIG. 1 is a perspective view of an electrical connector according to an embodiment;

FIG. 2 is a plan view of a housing of the electrical connector of FIG. 1;

FIG. 3 is an enlarged plan view of the housing of FIG. 2;

FIG. 4 is a sectional view along line IV-IV of FIG. 2;

FIG. 5 is a sectional view along line V-V of FIG. 2;

FIG. 6 shows both a plan view and a sectional view of a seal member according to an embodiment;

FIG. 7 is a plan view of the electrical connector of FIG. 1;

FIG. 8 is a sectional view along line VIII-VIII of FIG. 7; and

FIG. 9 is a sectional view along line IX-IX of FIG. 7.

### DETAILED DESCRIPTION

With reference to the drawings, the embodiments of the invention will be described as below.

The figures each show an XYZ Cartesian coordinate system as necessary for explanation. Further, when taking the point where the X and Y axes intersect as the origin, the radial direction RD refers to the direction extending radially from the origin on the paper surface, and the circumferential direction CD refers to the direction that is either clockwise or counterclockwise, or both clockwise and counterclockwise, regarding the origin as the center on the paper surface.

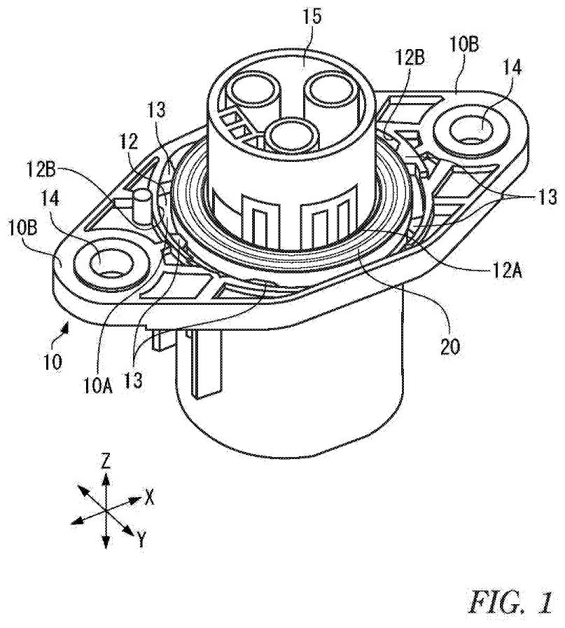

An embodiment of an electrical connector 1 will now be described with reference to FIGS. 1-9. As shown in FIG. 1, the electrical connector 1, as a waterproof electrical connector 1, comprises a housing 10, and a seal member 20 held in the housing 10. The electrical connector 1 is mechanically connected and electrically connected with a mating side connector while fitting. The electrical connector 1, for example, has a contour that compared with one (X-axis) of two orthogonal axes, the other (Y-axis) is smaller, so an expansion allowance can be ensured even if the shape of a groove within which the seal member 20 is provided is restricted. In other words, the electrical connector 1 is a waterproof electrical connector 1 that can ensure the expansion allowance even if the shape of the seal groove 12 within which the seal member 20 is provided is restricted.

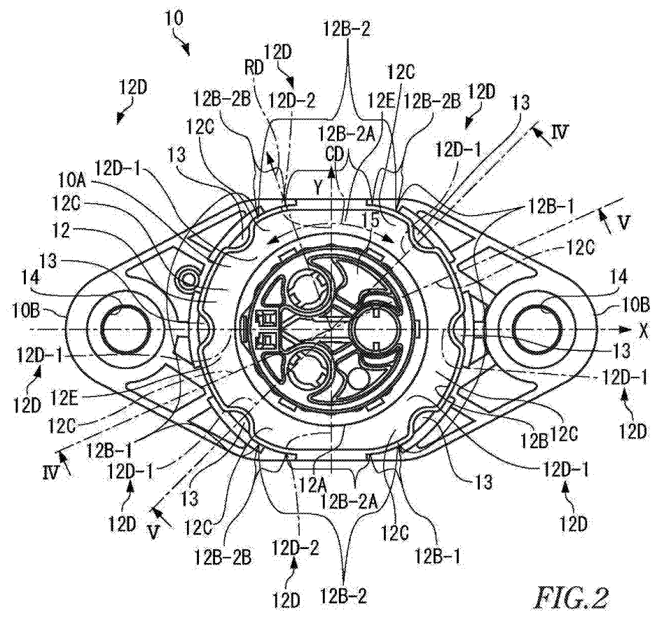

The housing 10 comprises a seal receiving housing 10A, as shown in FIGS. 1-2, provided with the seal member 20, and a pair of fixing portions 10B, as shown in FIGS. 1-2, arranged at point-symmetrical positions regarding the seal receiving housing 10A as the center and involved in the fixing with a mating side connector. In other words, the pair of fixing portions 10B involved in the fixing with the mating side connector are arranged at symmetrical positions regarding the seal receiving housing 10A as the center. Additionally, the seal receiving housing 10A is in between the pair of fixing portions 10B. The housing 10, as an example, is formed as a whole by injection molding a resin material which makes the seal receiving housing 10A and the fixing portions 10B electrically insulated.

As shown in FIGS. 1-2, the seal receiving housing 10A comprises a seal groove 12 within which the seal member 20 is provided, and seal member pressers 13 preventing the seal member 20 provided in the seal groove 12 from slipping out of the seal groove 12.

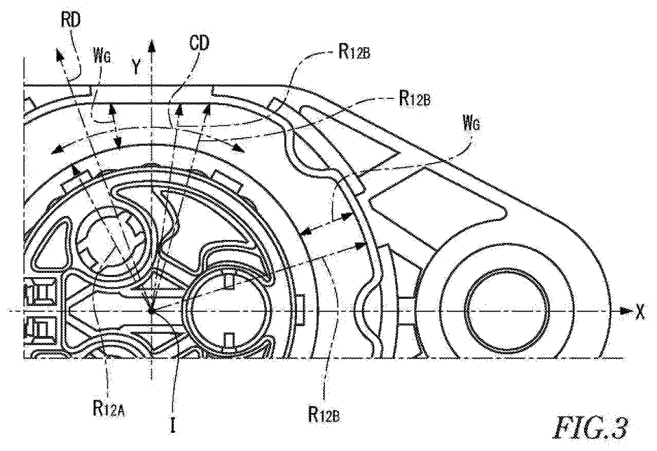

The seal groove 12, as shown in FIG. 2, is arranged to surround a contact holding portion 15. When viewing the seal groove 12 in plan view, the seal groove 12 is disposed between an inner wall 12A arranged inwardly in the radial direction RD and an outer wall 12B arranged outwardly in the radial direction RD spaced from the inner wall 12A. The seal groove 12 is configured to be a linear symmetrical shape respectively in the up-down direction and the left-right direction on the paper surface with respect to the intersection point I of the X and Y axes, and generally to be circular in shape. As shown in FIG. 3, the intersection point I is also the center of the seal receiving housing 10A.

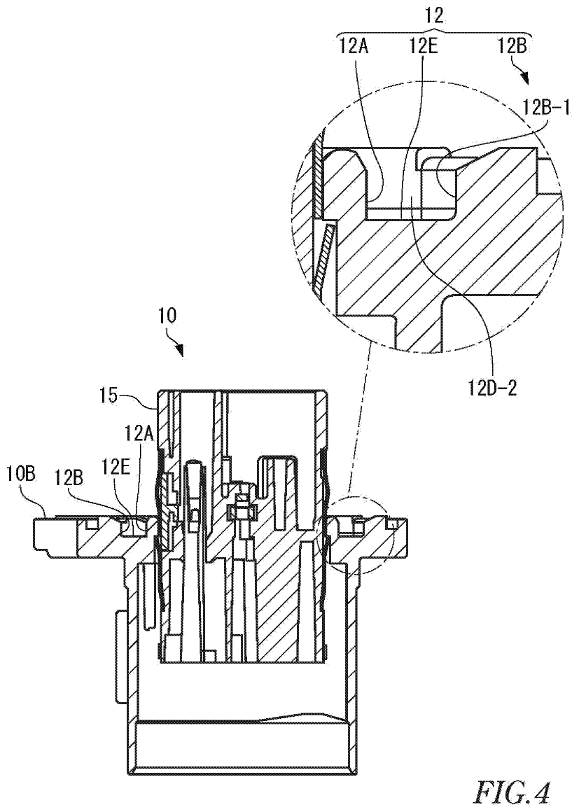

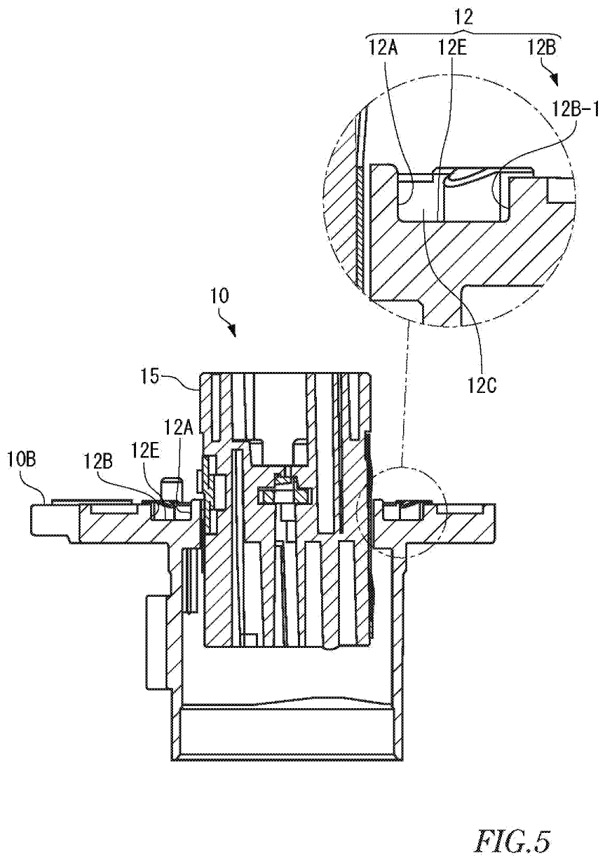

As shown in FIG. 2, the seal groove 12 comprises a plurality of wide-width regions 12C and a plurality of narrow-width regions 12D in the circumferential direction CD along which the seal groove 12 extends. As shown in FIG. 3, the wide-width regions 12C have greater dimension WG in the radial direction RD than the narrow-width regions 12D. The narrow-width regions 12D include narrow-width regions 12D-1 and narrow-width regions 12D-2. As shown in FIGS. 4-5, the seal groove 12 includes a groove bottom 12E formed to connect between the inner wall 12A and the outer wall 12B.

The inner wall 12A is formed to constitute a perfect circle. In other words, as shown in FIG. 3, the inner wall 12A has a dimension (R12A) in the radial direction RD that is constant throughout the circumferential direction CD. It is sufficient as long as the perfect circle has roundness with a degree being able to be achieved on the industrial scale of production.

As shown in FIG. 3, the outer wall 12B has a dimension (R12B) in the radial direction RD that varies in the circumferential direction CD. This is based on the existence of the limitation that the dimension of the seal receiving housing 10A in the Y-axis direction must be smaller than the dimension in the X-axis direction.

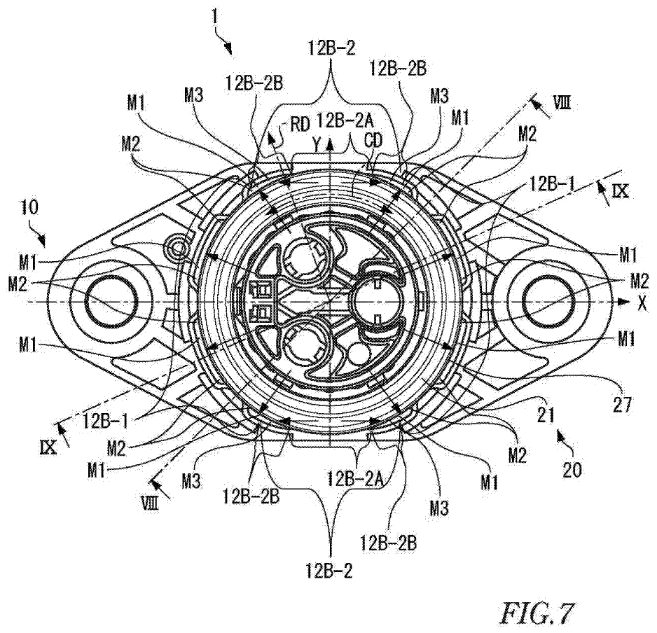

As shown in FIGS. 2 and 7, the outer wall 12B is composed of outer walls 12B-1 and outer walls 12B-2. The outer walls 12B-2 correspond to the limitation that the dimension in the Y-axis direction must be reduced.

As shown in FIGS. 2 and 7, the outer walls 12B-1, when viewing the seal groove 12 in plan view, are formed in arc shapes regarding the intersection point I as the center. Regarding the outer walls 12B-1, it is provided with a pair of outer walls 12B-1 located at the positions linearly symmetrical with respect to the Y-axis, the arc of each of the outer walls 12B-1 has the same radius. In other words, the outer walls 12B-1, as second regions, are located at mutually symmetrical positions. Further, the arc of each of the outer walls 12B-1 has a larger radius than the seal member 20.

As shown in FIGS. 2 and 7, the outer walls 12B-2, when viewing the seal groove 12 in plan view, comprise outer walls 12B-2A formed in straight line shapes parallel to the X-axis direction along the contour of the housing 10, and outer walls 12B-2B formed in arc shapes connected to both sides of the outer walls 12B-2A. The arc-shaped outer walls 12B-2B connect towards the adjacent outer walls 12B-1, respectively. In other words, the outer walls 12B-2 comprise outer walls 12B-2A which are straight line-shaped portions, and outer walls 12B-2B which are arc-shaped portions connected to both sides of the outer walls 12B-2A of the straight line-shaped portions.

As shown in FIGS. 2 and 7, a pair of outer walls 12B-2 are arranged at positions linearly symmetrical with respect to the X-axis. In other words, the outer walls 12B-2, as first regions, are located at mutually symmetrical positions.

Here, the outer walls 12B-1 have a greater dimension (R12B), as shown in FIG. 3, in the radial direction than the outer walls 12B-2. Further, the curvature of the arc-shaped outer walls 12B-1 regarding the intersection point I as the center is determined by the radius of the dimension (R12B) in the radial direction RD, and is constant.

As shown in FIGS. 2 and 7, the straight line-shaped outer walls 12B-2A of the outer walls 12B-2, which are arranged inwardly in the radial direction RD relative to the outer walls 12B-1, are located at positions equivalent to the positions of tangents of the arc-shaped outer walls 12B-1, and since the arc-shaped outer walls 12B-2B, which are continuous on both sides of the outer walls 12B-2A respectively, connect towards the outer walls 12B-1, the curvature of the outer walls 12B-2 being the first regions are smaller than that of the outer walls 12B-1 being the second regions.

The outer walls 12B-2A, as shown in FIGS. 2 and 7, when viewing the seal groove 12 in plan view, are in straight line shapes parallel to the X-axis direction, but it is not limited to this. Regarding a part of the outer walls 12B-2A, it can also be arranged in a corrugated shape wherein peaks with minute height and valleys with minute depth are continuous. Further, it may also be an arc shape protruding outwardly in the radial direction RD. Further, a plurality of arcs protruding outwardly in the radial direction RD may be formed continuously.

The wide-width regions 12C, as shown in FIG. 2, are composed of the inner wall 12A, the groove bottom 12E, and the outer walls 12B-1. In the circumferential direction CD, the dimension WG of the wide-width regions 12C in the radial direction RD is constant.

The narrow-width regions 12D-1, as shown in FIG. 2, are composed of the inner wall 12A, the groove bottom 12E, and the seal member pressers 13. For example, in the circumferential direction CD, the dimension WG of the narrow-width regions 12D-2 on line IV-IV in the radial direction RD becomes the smallest, and the dimension increases as moving away from the line IV-IV, wherein, the line IV-IV connects the center of the circular inner wall 12A and the center of the arcs of the seal member pressers 13.

As shown in FIG. 2, the narrow-width regions 12D-2 are composed of the inner wall 12A, the groove bottom 12E, and the outer walls 12B-2. For example, in the circumferential direction CD, the dimension WG of the narrow-width regions 12D-2 in the radial direction RD becomes the smallest on the Y-axis, and the dimension increases as moving away from the Y-axis.

The seal member pressers 13 press the seal member 20 and stabilize it in the seal groove 12 when the seal member 20 is provided in the seal groove 12. When viewing the seal groove 12 in plan view, at least one seal member presser 13, as shown in FIG. 2, is formed in an arc shape protruding towards the inside of the seal receiving housing 10A, and on each of its both sides in the circumferential direction CD, the seal member presser 13 is linked with the outer walls 12B-1. In this embodiment, when viewing the seal groove 12 in plan view, the seal member pressers 13 are formed in arc shapes protruding towards the intersection point I which is the center of the seal receiving housing 10A, and in the circumferential direction CD of the seal groove 12, six seal member pressers 13 are provided at the symmetrical positions regarding the seal receiving housing 10A as the center, the arc of each of the seal member pressers 13 has the same radius. Besides, the seal member pressers 13 are excluded from defining the dimension in the radial direction RD on the outer wall 12B.

As shown in FIGS. 1-2, the fixing portions 10B are provided with fastening holes 14, through which bolts, screws and other fasteners penetrate to connect the electrical connector 1 with the mating side electrical connector. The fastening holes 14 are formed to penetrate towards the Z-axis direction of the fixing portions 10B. The fastening holes 14 are formed at positions corresponding to bolt holes arranged in the mating side connector of the electrical connector 1, where female screws are formed. The electrical connector 1 is fastened to the mating side connector by bolts inserted in the fastening holes 14 and the bolt holes. In this embodiment, two fastening holes 14 are arranged on the left and right sides of the X-axis of the housing 10.

As shown in FIGS. 1-2, 4-5, and 8-9, the contact holding portion 15 is located in the center of the housing 10. The contact holding portion 15 receives a plurality of contacts connected to a plurality of wires. The plurality of contacts received in the contact holding portion 15 are respectively electrically connected to a plurality of contacts of the mating side connector.

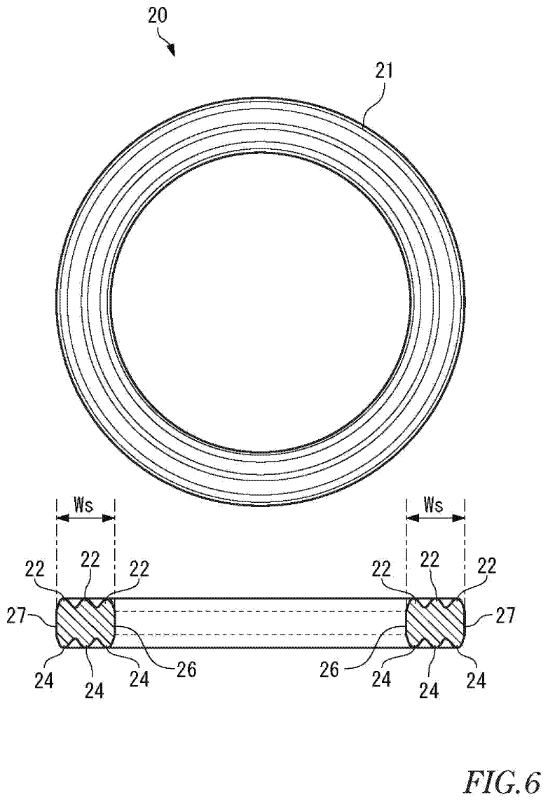

The seal member 20 is in charge of waterproofing between the electrical connector 1 and the mating side connector by elastically closely contacting the both in the state of fitting and securing the electrical connector 1 with the mating side connector. As shown in FIG. 6, the seal member 20 comprises a seal member body 21, a plurality of lips 22 formed on one side of the front and back of the seal member body 21, and a plurality of lips 24 formed on the other side of the front and back of the seal member body 21. As an example, there are three of the lips 22 and three of the lips 24.

Regarding the seal member 20, the seal member body 21 and the lips 22, 24 are integrally formed by injection molding, utilizing an elastic material such as natural rubber, silicone rubber, etc. As shown in FIG. 6, in this embodiment, when viewing the seal member 20 in plan view, the seal member body 21 is formed in a ring shape. In other words, the seal member 20 is formed in an annular shape. In the seal member body 21, as shown in FIG. 6, the inside of the radial direction RD is partitioned by an inner circumferential surface 26 and the outside of the radial direction RD is partitioned by an outer circumferential surface 27.

The lips 22 protrude outwardly from an open side of the seal groove 12 when the seal member 20 is provided in the seal groove 12. The portion protruding outwardly is crushed and closely contacts the mating side connector which is fitted and secured with the electrical connector 1, thereby performing a waterproof function. The lips 24 butts up against the groove bottom 12E of the seal groove 12 when the seal member 20 is provided in the seal groove 12. When the electrical connector 1 and the mating side connector are fitted and secured, this butting portion is crushed and closely contacts the groove bottom 12E, thereby performing a waterproof function.

The inner circumferential surface 26 is in contact with the inner wall 12A when the seal member 20 is provided in the seal groove 12. In this embodiment, the inner diameter of the seal member body 21 in an unloaded state formed by the inner circumferential surface 26 is smaller than the diameter formed by the inner wall 12A. Therefore, when the seal member 20 is provided in the seal groove 12, the seal member body 21 is elastically deformed and expanded outwardly in the radial direction RD. The outer circumferential surface 27 is in contact with the seal member pressers 13 and the outer walls 12B-2 when the seal member 20 is provided in the seal groove 12. In this embodiment, when the seal member 20 is provided in the seal groove 12, the seal member body 21 is expanded outwardly in the radial direction RD, and further is compressed inwardly in the radial direction RD by butting against the seal member pressers 13 and the outer walls 12B-2.

The relationship between the housing 10 and the seal member 20 will now be described with reference to FIGS. 7-9. FIG. 7 is a plan view of the electrical connector 1 in which the seal member 20 is provided in the seal groove 12 of the housing 10 in this embodiment.

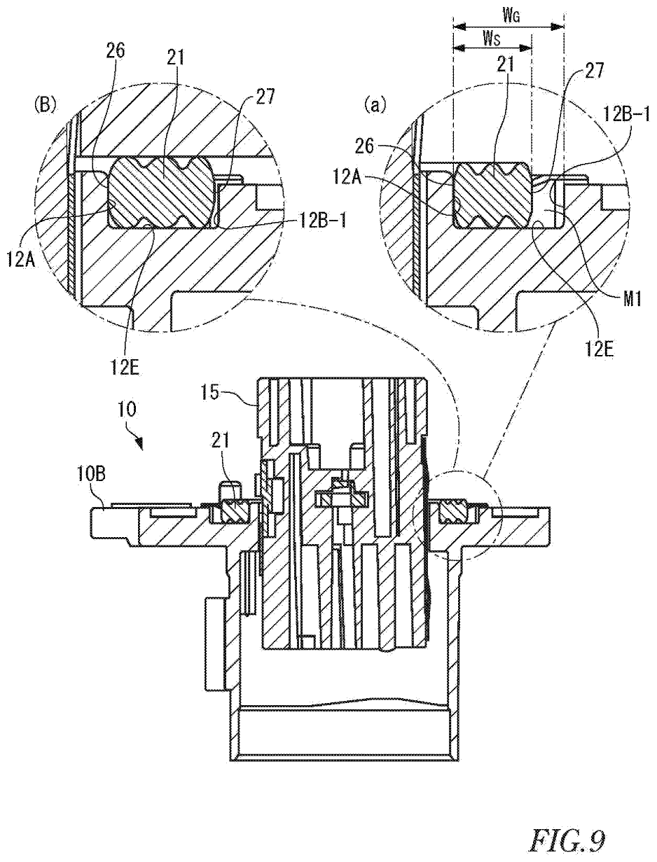

When the seal member 20 is provided in the seal groove 12, in the wide-width regions 12C, since the radius of the arc shape of the outer walls 12B-1 is larger than the radius of the seal member 20, the outer circumferential surface 27 of the seal member 20 and the outer walls 12B-1 are provided with a gap M1 therebetween. The gap M1, as shown in FIGS. 7 and 9, is an expansion allowance of the seal member 20 outward in the radial direction RD in a range sandwiched between the outer walls 12B-1 and the inner wall 12A.

In the narrow-width regions 12D-1, when the seal member 20 is expanded outwardly in the radial direction RD by bringing the inner circumferential surface 26 into contact with the inner wall 12A, as for the range where the dimension WG of the narrow-width regions 12D-1 in the radial direction RD is smaller than the dimension WS of the seal member body 21 in the radial direction RD, the outer circumferential surface 27 elastically closely contacts along the arc-shaped seal member pressers 13. As for the range where the dimension WG of the narrow-width regions 12D-1 in the radial direction RD is greater than the dimension WS of the seal member body 21 in the radial direction RD, the outer circumferential surface 27 and the arc-shaped seal member pressers 13 are provided with a gap M2 therebetween. The gap M2, as shown in FIG. 7, is an expansion allowance of the seal member 20 outward in the radial direction RD in a range sandwiched between the outer walls 12B-1 and the seal member pressers 13.

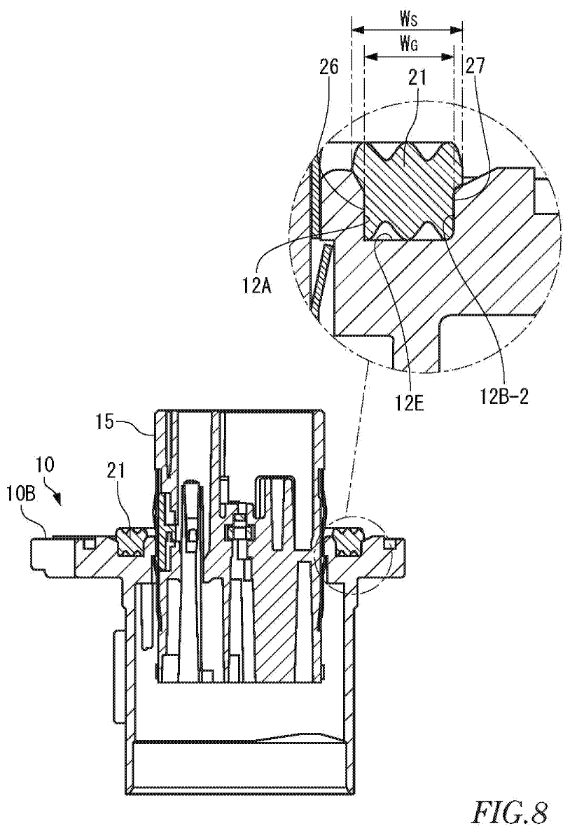

FIG. 8 is a sectional view of the electrical connector 1 at the position where the dimension WG in the radial direction RD becomes the smallest in the narrow-width regions 12D-1. As shown in FIG. 8, when the seal member 20 is provided in the seal groove 12, the seal member body 21 is compressed in the case that the dimension WG of the seal groove 12 in the radial direction RD is smaller than the dimension WS of the seal member body 21 in the radial direction RD. The length of the seal member body 21 in the height direction is greater than the groove depth of the seal groove 12. When the electrical connector 1 is connected with the mating side connector, the seal member body 21 elastically closely contacts the groove bottom 12E of the seal groove 12 and elastically closely contacts the contact surface of the mating side connector when the surface of the electrical connector 1 facing the mating side connector and the surface of the mating side connector facing the electrical connector 1 are in contact.

FIG. 9 is a sectional view of the electrical connector 1 at the wide-width regions 12C. As shown in the enlarged sectional view in the upper left of FIG. 9, it is sealed between the inside where the contact holding portion 15 of the electrical connector 1 is arranged and the outside where the fastening holes 14 are arranged, by the seal member body 21 of the elastically closely contacted annular component. In the wide-width regions 12C, when the electrical connector 1 is fitted with the mating side connector, the seal member body 21 is expanded towards the gap M1 outside the radial direction RD.

In the narrow-width regions 12D-1, when the electrical connector 1 is fitted with the mating side connector, in the seal member body 21, a force aiming to expand in the circumferential direction CD is generated in the range where the seal member body 21 elastically closely contacts along the arc-shaped seal member pressers 13. Further, except for the range where the seal member body 21 elastically closely contacts along the arc-shaped seal member pressers 13, in the seal member body 21, a force aiming to expand outwardly in the radial direction RD is generated. In other words, in the seal member body 21, a force aiming to expand in the circumferential direction CD and a force aiming to expand outwardly in the radial direction RD are to be generated. Except for the range where the seal member body 21 elastically closely contacts along the arc-shaped seal member pressers 13, the seal member body 21 in the range sandwiched between the outer walls 12B-1 and the seal member pressers 13 is expanded toward the gap M2 outside the radial direction RD.

In the narrow-width regions 12D-2, when the seal member body 21 is expanded outwardly in the radial direction RD by bringing the inner circumferential surface 26 into contact with the inner wall 12A, as for the range where the dimension WG of the narrow-width regions 12D-2 in the radial direction RD is smaller than the dimension WS of the seal member body 21 in the radial direction RD, the outer circumferential surface 27 elastically closely contacts along the outer walls 12B-2. As for the range where the dimension WG of the narrow-width regions 12D-2 in the radial direction RD is greater than the dimension WS of the seal member body 21 in the radial direction RD, the outer circumferential surface 27 and the outer walls 12B-2 are provided with a gap M3 therebetween. The gap M3, as shown in FIG. 7, is an expansion allowance of the seal member 20 towards both sides of the X-axis direction parallel to the straight line-shaped outer walls 12B-2A in a range sandwiched between the outer walls 12B-2 and the inner wall 12A.

Here, although if the curvature of the outer walls 12B-2 that constitutes the narrow-width regions 12D-2 is large, the gap M3 provided between the outer walls 12B-2 and the outer circumferential surface 27 will become smaller, the smaller the curvature of the outer walls 12B-2 that constitutes the narrow-width regions 12D-2 is, the larger the gap M3 arranged between the outer walls 12B-2 and the outer circumferential surface 27 can be ensured, and the larger expansion allowance of the seal member 20 can be ensured.

In the narrow-width regions 12D-2, when the electrical connector 1 is fitted with the mating side connector, in the seal member body 21, a force aiming to expand in the circumferential direction CD is generated in the range where the seal member body 21 elastically closely contacts along the straight line-shaped outer walls 12B-2A. Further, except for the range where the seal member body 21 elastically closely contacts along the straight line-shaped outer walls 12B-2A, in the seal member body 21, a force aiming to expand outwardly in the radial direction RD is generated. In other words, in the seal member body 21, a force aiming to expand in the circumferential direction CD and a force aiming to expand outwardly in the radial direction RD are to be generated. Here, the seal member body 21 in the range sandwiched between the outer walls 12B-2 and the inner wall 12A expands towards the gap M3, which is the expansion allowance on both sides in the X-axis direction parallel to the straight line-shaped outer walls 12B-2A, and becomes larger as the curvature of the outer walls 12B-2 decreases.

Besides, in the seal member body 21, compressive stress is generated in the radial direction RD, the circumferential direction CD and the Z-axis direction. The force pressing the housing 10 is locally excessive because of the seal member body 21 generating the compressive stress.

However, even though it is difficult in the electrical connector 1 to arrange a seal groove 12 provided with even expansion allowances radially due to the contour of the housing 10, it is sealed between the inside where the contact holding portion 15 of the electrical connector 1 is arranged and the outside where the fastening holes 14 are arranged by ensuring an expansion allowance towards both sides in the X-axis direction parallel to the straight line-shaped outer walls 12B-2A along the contour of the housing 10, without an excessive repulsive force to the housing 10.

The electrical connector 1 comprises a seal receiving housing 10A with a seal groove 12, within which a seal member 20 is provided, between an inner wall 12A arranged inwardly in the radial direction RD and an outer wall 12B arranged outwardly in the radial direction RD relative to the inner wall 12A, the outer wall 12B comprises outer walls 12B-2 being the first regions having a small dimension (R12B) in the radial direction RD, and outer walls 12B-1 being the second regions having a dimension (R12B) in the radial direction RD greater than the outer walls 12B-2, the outer walls 12B-2 including outer walls 12B-2A formed in a straight line shape is smaller in curvature than the outer walls 12B-1.

Such electrical connector 1 can ensure an expansion allowance of the seal member 20 when fitted with the mating side connector, even if the shape of the seal groove 12 receiving the seal member 20 is restricted by the contour of the housing 10.

In addition to the above, it is possible to discard some configurations listed in the above embodiments or change them to other configurations as appropriate, as long as the main purpose of the invention is not departed from.

In this embodiment, a pair of outer walls 12B-2, i.e., two outer walls 12B-2 in the Y-axis direction, are arranged at the positions linearly symmetrical with respect to the X-axis, but it is not limited to this. Also, the outer walls 12B-2 for example can be provided in the Y-axis. Further, one outer wall 12B-1 is connected to both sides of the outer walls 12B-2, and a seal groove 12 is annularly formed. Further, the outer walls 12B-2 have a curvature smaller than the outer walls 12B-1. Even though the electrical connector 1 is configured like this, since a gap M3, as an expansion allowance, is provided on both sides of the X-axis direction parallel to the outer walls 12B-2A formed in a straight line shape in the outer walls 12B-2, it is sealed between the inside where the contact holding portion 15 of the electrical connector 1 is arranged and the outside where the fastening holes 14 are arranged, without an excessive repulsive force toward the housing 10.

In light of the typical shape of a housing of a connector, the shape of a groove within which a seal member is provided is restricted by the contour of the typical housing. For example, it is the case that regarding the dimension in a radial direction, compared with that in one (which is the X-axis) of two orthogonal axes, that in the other (the Y-axis) is smaller. In this case, it is impossible to ensure an expansion allowance of the seal member when fitting connectors with each other, and a force that presses the housing defining the groove is locally excessive because of the expansion of the seal member.

Consequently, given the above, the present invention provides a waterproof electrical connector 1 that can ensure an expansion allowance of the seal member 20 when the electrical connector 1 is fitted with the mating side connector, wherein the seal groove 12 on the housing 10 of the electrical connector 1 has a shape restricted by the contour of the electrical connector 1. Thus, according to the present invention, the electrical connector 1 can ensure the expansion allowance of the seal member 20 when the electrical connector 1 is fitted with the mating side connector even if the shape of the seal groove 12 receiving the seal member 20 is restricted by the contour of the electrical connector 1.

1. A waterproof electrical connector, comprising:
an annular seal member; and
a seal receiving housing having a seal groove, the seal member is provided in the seal groove between an inner wall arranged inwardly in a radial direction and an outer wall arranged outwardly in the radial direction relative to the inner wall, the outer wall has first regions and second regions, the first regions have a dimension in the radial direction, the second regions have a dimension in the radial direction greater than the dimension of the first regions, a curvature of the first regions are smaller than a curvature of the second regions.

2. The waterproof electrical connector of claim 1, wherein the first regions are located at mutually symmetrical positions.

3. The waterproof electrical connector of claim 2, wherein the second regions are located at mutually symmetrical positions.

4. The waterproof electrical connector of claim 3, wherein the first regions have straight line-shaped portions and arc-shaped portions connected to both sides of the straight line-shaped portions.

5. The waterproof electrical connector of claim 3, further comprising a pair of fixing portions fixing with a mating side connector, the pair of fixing portions are arranged at symmetrical positions with respect to the seal receiving housing.

6. The waterproof electrical connector of claim 5, wherein the seal receiving housing is in between the pair of fixing portions.

7. The waterproof electrical connector of claim 5, wherein the pair of fixing portions are respectively provided with fastening holes.

8. The waterproof electrical connector of claim 4, wherein the second regions are formed in an arc shape.

9. The waterproof electrical connector of claim 8, wherein the waterproof electrical connector further comprises at least one seal member presser protruding toward an inside of the seal receiving housing.

10. The waterproof electrical connector of claim 9, wherein the at least one seal member presser prevents the seal member from slipping out of the seal groove.

11. The waterproof electrical connector of claim 9, wherein the at least one seal member presser is formed in an arc shape.

12. The waterproof electrical connector of claim 8, wherein the waterproof electrical connector further comprises a plurality of seal member pressers protruding towards an inside of the seal receiving housing.

13. The waterproof electrical connector of claim 12, wherein the seal member pressers are provided at symmetrical positions with respect to the seal receiving housing.

14. The waterproof electrical connector of claim 9, wherein a gap is formed between an outer circumferential surface of the seal member and the at least one seal member presser.

15. The waterproof electrical connector of claim 1, wherein the second regions are formed in an arc shape, a radius of the arc shape of the second regions is greater than a radius of the seal member.

16. The waterproof electrical connector of claim 1, wherein a gap is formed between an outer circumferential surface of the seal member and the second regions.

17. The waterproof electrical connector of claim 1, where a gap is formed between an outer circumferential surface of the seal member and the first regions.

18. The waterproof electrical connector of claim 1, wherein the waterproof electrical connector further comprises at least one seal member presser protruding toward an inside of the seal receiving housing, a gap is formed between an outer circumferential surface of the seal member and the at least one seal member presser, a gap is formed between the outer circumferential surface of the seal member and the second regions, and a gap is formed between the outer circumferential surface of the seal member and the first regions.

19. The waterproof electrical connector of claim 18, wherein a plurality of lips are formed on both a front and a back of a seal member body of the seal member.
